(19) United States
(12) Patent Application Publication
(10) Pub. No.: US 2025/0073779 A1
(43) Pub. Date: Mar. 6, 2025

(54) SYSTEM FOR ADDITIVE MANUFACTURING HAVING A MOVABLE OUTLET

(71) Applicant: GM Global Technology Operations LLC, Detroit, MI (US)

(72) Inventors: Paul J. Wolcott, Macomb, MI (US); Ante Tony Lausic, Burlington (CA)

(73) Assignee: GM Global Technology Operations LLC, Detroit, MI (US)

(21) Appl. No.: 18/462,106

(22) Filed: Sep. 6, 2023

(51) Int. Cl. B22F 10/366; B22F 10/28; B22F 12/00; B22F 12/47; B29C 64/153; B29C 64/236; B29C 64/268; B29C 64/393; B33Y 10/00; B33Y 30/00; B33Y 50/02

(52) U.S. Cl. CPC B22F 10/366; B22F 10/28; B22F 12/224; B22F 12/47; B29C 64/153; B29C 64/236; B29C 64/268; B29C 64/393; B33Y 10/00; B33Y 30/00; B33Y 50/02

(57) ABSTRACT

A system and method for additive manufacturing includes a fusing mechanism, an outlet and a controller. The system and method is performed in a chamber containing a layer of particle. The fusing mechanism transmits a beam for fusing particles in the layer of particles. The fusing mechanism is configured to move the beam in a fusing path extending from one end of the chamber to another end of the chamber in a first direction. The outlet is movable in the first direction and configured to blow air in a second direction opposite of the first direction. The controller is configured to move the outlet in the first direction and keep the outlet upstream of the beam.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to a system and method for additive manufacturing. With reference now to FIG. 1, a depiction of an additive manufacturing process commonly referred to as powder bed fusion is shown. The additive manufacturing process is performed in a chamber 100 having a layer of particles 102 to be fused together to form a desired component. The particles are fused together by a beam “B” such as a laser beam or an electron beam. The process is an iterative process in which particles in the layer 102 are fused together and then another layer 102 of particles is added and fused together until the component is printed.

The energy of the beam “B” generates a cloud of particles “CP” which are dispersed upwardly from the layer of particles 102. As a result, the cloud of particles “CP” absorb energy from the beam and may result is an undesirable fusing process. For instance, the energy from the beam may be absorbed by the particles in the cloud resulting in a reduced power for fusing the particles. Further, the energy from the beam may fuse particles in the cloud to form a fused particle “FP” that may fall in an undesirable/unintended location creating a defect in the printed component.

With reference now to FIG. 2, current systems employ a blower 104 and an outlet 106 which is fixed to one end of the chamber 100. The outlet 106 directs gas, such as an inert gas, from one end of the chamber 100 into an inlet 108. The blower 104 is configured to blow the gas through the outlet 106 at a flow rate that is strong enough to carry away particles from the cloud into the inlet 108 without disturbing the particles in the layer of particles 102. Thus, FIG. 2 depicts the gas being blown over the layer of particles 102 without blowing away particles with the layer 102 and carrying away particles in the cloud into an inlet 108.

With reference now to FIG. 3, an illustrative depiction of a chamber 100 for additive manufacturing is provided. A beam generator 110 is disposed within the chamber 100 and is configured to generate a beam for fusing the particles together. The chamber 100 includes an outlet 106 that fixed on one end of the chamber 100 and disposed above the layer of particles 102 so as to not blow directly on the layer of particles 102. Thus, it should be appreciated that the outlet 104 is positioned to only affect the cloud of particles generated by the beam “B” fusing the particles, and not the layer of particles 102 itself.

With reference again to FIG. 3 and now to FIG. 4, the strength of the gas blown though the outlet 106 decreases over distance as indicated by the decrease in the size of the arrows. As stated above, the outlet 106 is fixed to a first end of the chamber 100 and an inlet 108 may be fixed to a second end of the chamber 100. The beam is transmitted from the beam generator 110 which directs the beam along a fusing path that moves along a length of the chamber 100 from the first end to the second end. As the outlet 106 is fixed to first end of the chamber 100, the blower 104 is very effective at carrying away particles in a cloud when the fusing process occurs close to the outlet 106. However, the effectiveness of the blower decreases the further away the fusing process occurs from the outlet 106. Thus, conventional chambers 100 are designed to have a layer of powder arranged along a length of approximately 400 mm. FIG. 4 depicts the strength of flow of gas being relatively the same as the gas is blown over a distance of 400 mm and decreases rapidly beyond 400 mm. Thus, increasing the length of the chamber 100 reduces the effectiveness of the blower and increasing the strength of the blower to increase the length of the chamber 100 would disturb the particles in the layer of particles leading to an uneven layer thickness after fusion.

While conventional systems adequately blow away the particles in a cloud generated by the fusing process, the length of the layer of particles within the chamber is limited to approximately 400 mm and, thus, the length of the component is limited to less than 400 mm. Accordingly, it remains desirable to increase the length of the chamber, thereby increasing the size of the component capable of being printed. Further, it is desirable to remove the particles in the cloud generated during fusion to provide an unobstructed path for the laser to perform fusion. Further yet, it is desirable to eliminate defects in the printing process by removing particles fused in the cloud from the chamber.

### SUMMARY

In one configuration, a system for additive manufacturing includes a fusing mechanism, an outlet, and a controller. The system is performed in a chamber containing a layer of particles. The fusing mechanism transmits a beam for fusing particles in the layer of particles. The fusing mechanism is configured to move the beam in a fusing path extending from one end of the chamber to another end of the chamber in a first direction. The outlet is movable in the first direction and configured to blow air in a second direction opposite of the first direction. The controller is configured to move the outlet in the first direction and keep the outlet upstream of the beam.

The system may include one or more of the following optional features. For example, the beam may be a laser beam or an electron beam.

In one configuration, the outlet may extend along a width of the chamber.

In one configuration, the system may further include a rail extending along a length of the chamber and the outlet is movably disposed along the rail.

In one configuration, the system may include an inlet configured to draw air from within the chamber to an environment external to the chamber. In such a configuration, the inlet may be fixed on one end of the chamber and spaced apart from the outlet. The inlet may be dimensioned to extend along a width of the chamber. Alternatively, the inlet may be moveable with respect to the outlet to accommodate the fusing path of the beam.

In one configuration, the controller is configured to move the outlet and the inlet between a start position and an end position. In such a configuration, the controller may be configured to keep the outlet upstream of the beam and the inlet downstream the beam as the beam moves in the fusing path. The controller may be further configured to return the beam to the start position when the beam completes the fusing path.

In another configuration, a system for additive manufacturing includes a chamber containing a layer of particles, the system including a fusing mechanism transmitting a beam for fusing particles in the layer of particles. The fusing mechanism may be configured to move the beam in a fusing path extending from one end of the chamber to another end of the chamber in a first direction. The system includes an inlet movable in the first direction and configured to draw air in the first direction and a controller configured to move the inlet in the first direction and keep the inlet upstream of the beam. In such a configuration, the system may further include an outlet configured to blow air in the first direction, the outlet spaced apart from the inlet.

In another configuration, a method for performing additive manufacturing includes fusing particles in a layer of particles with a beam. The beam moves in a fusing path from one end of a chamber to another end of the chamber in a first direction. The method includes providing an outlet for blowing air in a second direction opposite of the first direction, and moving the outlet along the first direction. The method includes keeping the outlet upstream of the fusing path so as to blow air downstream of the fusing path.

In one configuration, fusing particles in a layer of particles with a beam includes using one of a laser beam and an electron beam.

In one configuration, the outlet may extend along a width of the chamber.

In one configuration, moving the outlet along the first direction includes moving the outlet along a rail that extends along a length of the chamber. In such a configuration, the method may include providing an inlet configured to draw air from within the chamber to an environment external to the chamber. In one aspect, the inlet apart may be spaced apart from the outlet a predetermined distance to accommodate the fusing path. In one aspect, the inlet may extend along a width of the chamber.

In one configuration, the method includes moving, by a controller, the inlet with respect to the outlet to accommodate the fusing path of the beam. In such a configuration, the method may include moving, by the controller, the outlet and the inlet between a start position and an end position. In yet another aspect of such a configuration, the method may include maintaining, by the controller, the outlet upstream of the beam and the inlet downstream of the beam as the beam moves in the fusing path, and returning the beam to the start position when the beam completes the fusing path.

### BRIEF DESCRIPTION OF THE DRAWINGS

The drawings described herein are for illustrative purposes only of selected configurations and are not intended to limit the scope of the present disclosure.

FIG. 1 is a perspective view of a fusing process of particles using a beam;

FIG. 2 is side view of a conventional system for additive manufacturing using a beam;

FIG. 3 is a perspective view of a conventional chamber for additive manufacturing showing an outlet fixed to one end of the chamber and the strength of a gas decreasing from one end of the chamber to the other;

FIG. 4 is schematic view showing how the strength of gas flow decreases over distance;

FIG. 5 is perspective view of a system for additive manufacturing showing an outlet moveable in a first direction and blowing air in a second direction opposite of the first direction;

FIG. 6 is top-down view of the system shown in FIG. 5 depicting rails being configured to provide gas into an outlet;

FIG. 7 is a side view showing operation of the system of FIG. 5;

FIG. 8 is perspective view of a system for additive manufacturing showing an inlet spaced apart from an outlet and moveable in a first direction;

FIG. 9 is top down view of the system shown in FIG. 8 depicting rails being configured to provide gas into the outlet;

FIG. 10 is a side view showing operation of the system of FIG. 8;

FIG. 11 is top-down view of a system for additive manufacturing showing an inlet moveable in a first direction and drawing air in a first direction;

FIG. 11 is top-down view of a system for additive manufacturing showing an inlet and an outlet both moveable in a first direction; and

FIG. 13 is a flow chart showing a method for additive manufacturing.

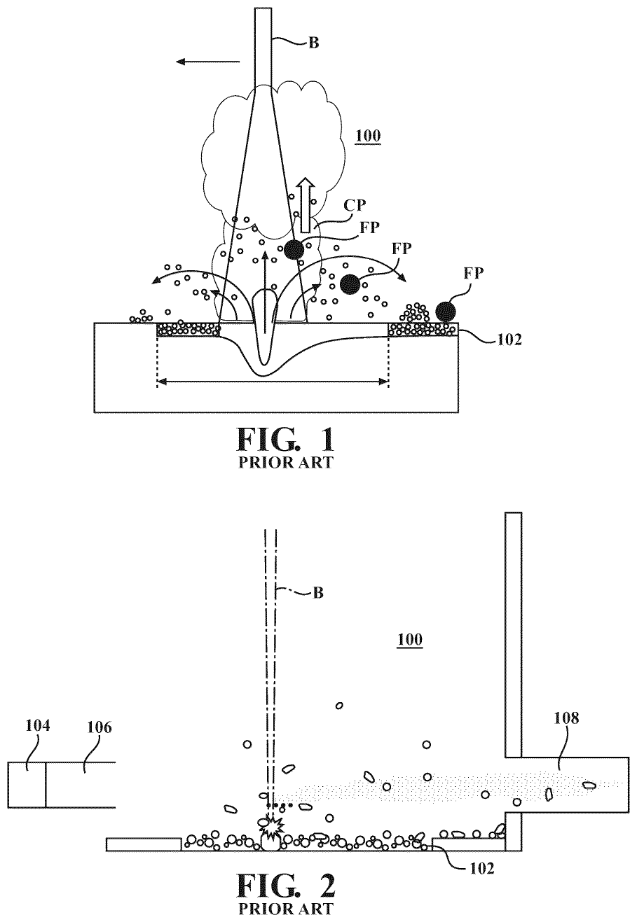

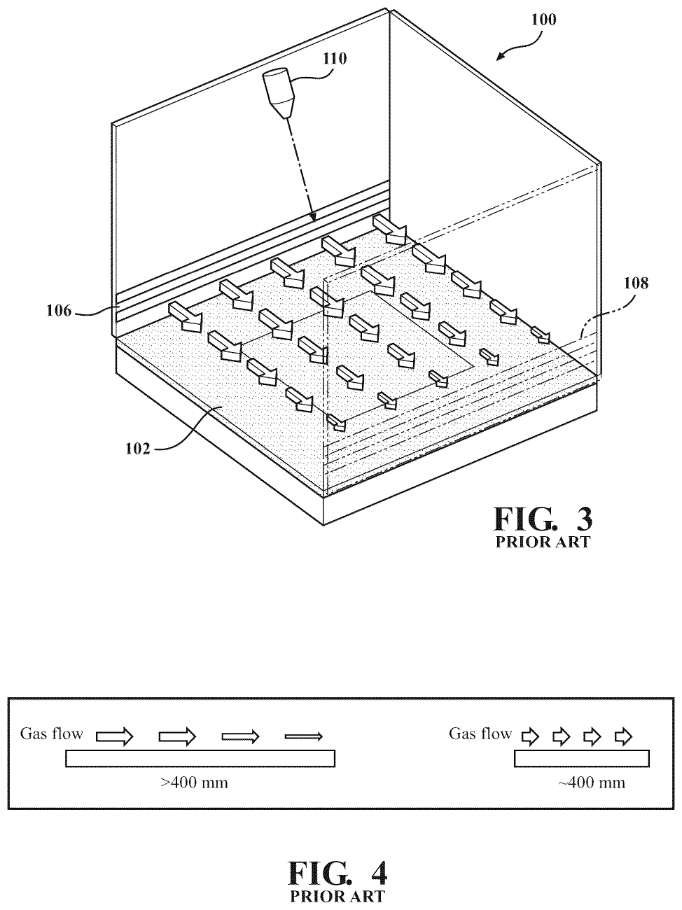

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A system and method for additive manufacturing includes a fusing mechanism, an outlet and a controller. The controller moves the outlet in the first direction and maintains the outlet upstream of the beam and the outlet is configured to blow air in a second direction opposite of the first direction thereby blowing away particles in a cloud out of the path of the beam of the fusing mechanism. As the outlet is moveable along the chamber, the size of the chamber is unlimited and thus the size of the component to be printed by the additive manufacturing process is also unlimited. Further, as the outlet moves with the fusing path of the beam, particles from the cloud are blown into the inlet and removed from the chamber thereby eliminating imperfections caused by particles of the cloud that are fused and fall onto the printed layer.

Additionally, the system and method may include an inlet that is spaced apart from the outlet and moveable along the first direction. The inlet provides a passage for particles from the cloud of particles to be removed from the chamber.

In one aspect, the outlet and the inlet are mounted onto a rail system and moveable along the rail system by a controller. The rail system may be configured to provide a conduit for gas. In yet another aspect, the rail system may be configured to distribute a layer of particles for fusing.

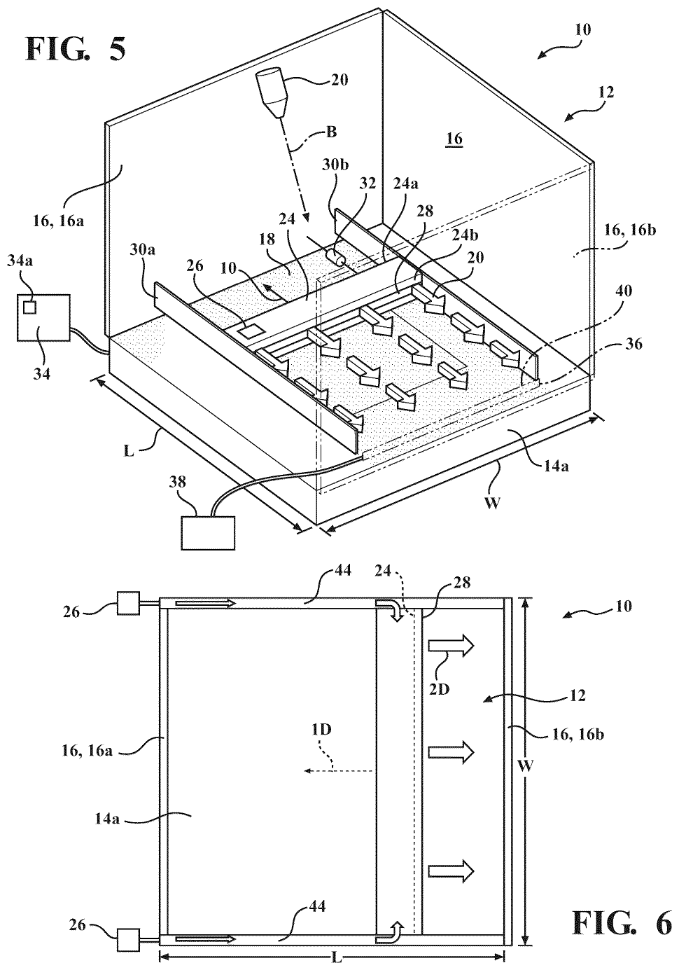

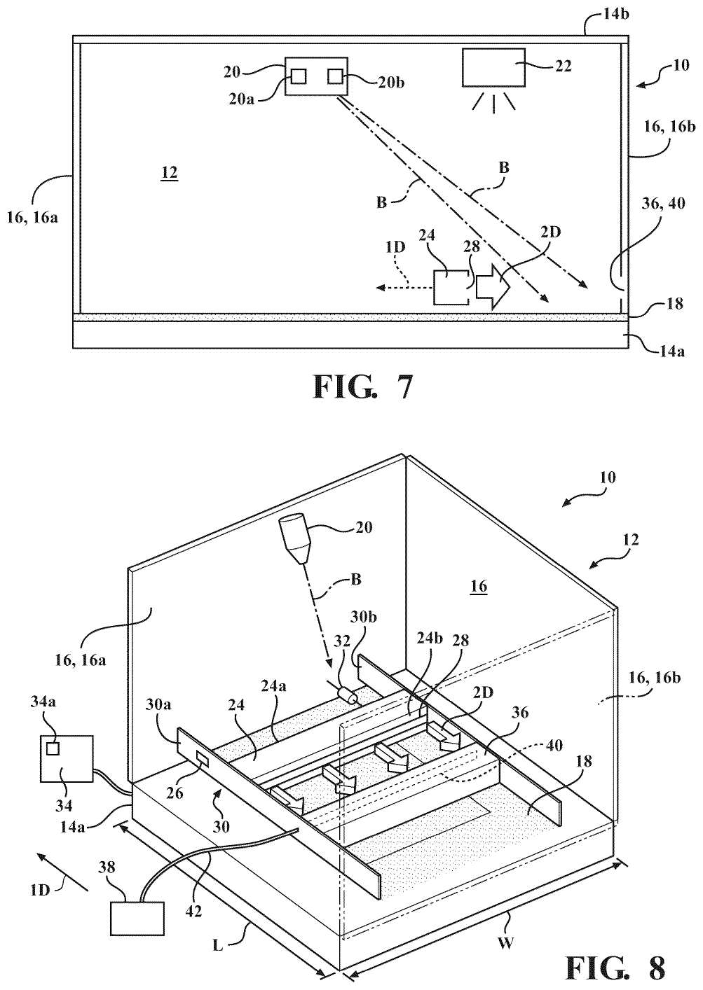

With reference to FIGS. 5-7 a system 10 for additive manufacturing configured to print a component (none shown) is provided. The system 10 is deployed within a chamber 12. The chamber 12 is enclosed by a bottom wall 14a, four side walls 16, and a top wall 14b (shown in FIG. 7). One of the side walls and the top wall is removed from FIG. 5 to facilitate the description of the system 10. One of the four side walls is a first wall 16a and another of the four side walls is a second wall 16b that is spaced apart from and faces the first wall 16a. The distance from the first wall 16a to the second wall 16b defines a length “L” of the chamber 12, and the width of the first wall 16a and the second wall 16b defines a width “W” of the chamber 12.

A layer of particles 18 to be fused together is placed on the bottom wall 14a of the chamber 12. As the particles are fused together, another layer of particles 18 is added and this process is repeated until the component is printed. In other words, the component is printed layer by layer. It should be appreciated that the added layer of particles 18 does not have to cover the entire bottom surface, but may be placed discretely onto the previous layer based upon the construct of the printed component. Any particles suitable for a fusing process currently known or later developed may be modified for use in the system 10, illustratively including metallic particles and polymer particles such as, for example, titanium, aluminum alloy, stainless steel, nickel and copper based alloys, nylon, nylon composites, polypropylene, thermoplastic resin and the like.

The system 10 includes a fusing mechanism 20 (shown in FIG. 7). The fusing mechanism 20 is configured to generate a beam of energy (as indicated by the arrow) having sufficient power to fuse the particles together. The fusing mechanism 20 may include one or more beam generators 20a, 20b. In one aspect, beam generator 20a is a laser beam generator for generating a laser beam and beam generator 20b is an electron beam generator for generating an electron beam. It should be appreciated that any fusing mechanism 20 for fusing particles together currently known or later developed may be modified for use herein.

The system 10 may include a dispensing mechanism 22 configured to dispense particles to form the layer of particles 18, illustratively shown in FIG. 7. Any dispensing mechanism 22 currently known and used in the art may be modified for use herein, illustratively including a hopper, a rake, a powder pumping device and the like. The dispensing mechanism 22 is disposed above the bottom wall 14a of the chamber 12 and is configured to selectively disperse the particles. For instance, the dispensing mechanism 22 may be moveable within the chamber 12 or may be fixed and include a movable or rotatable nozzle for distributing particles to a predetermined area of the chamber 12.

The fusing mechanism 20 transmits a beam “B” having sufficient energy for fusing the particles in the layer of particles 18. As discussed above, the fusing process creates a cloud of particles which may obstruct the beam and/or the beam may fuse the particles in the cloud and the fused particles may land on the printed layer creating undesirable defects. The fusing mechanism 20 is configured to move the beam “B” in a fusing path extending from one end of the chamber 12 to another end of the chamber 12 in a first direction “1D.” The first direction “1D” extends along the length of the chamber 12 from the first wall 16a to the second wall 16b.

It should be appreciated that the fusing path is not necessarily limited to one direction, but includes a pattern to be applied to a portion of the layer of particles 18 to be fused together to form the respective layer of the printed component. For instance, the fusing mechanism 20 may direct the beam along the entire width of the chamber 12 and along a predetermined length of the chamber 12, to define a fusing area, prior to advancing the beam in the first direction “1D.” Thus, as the beam is moved along the width, the beam may be further directed to cover a predetermined length of the layer of particles 18. In aspects where multiple laser beam generators 20a and/or electron beam generators 20b are used, multiple beams may be deployed, each beam moving in a pattern which, when taken together, form a printed layer of the component. Thus, the term fusing path is not limited to a movement of the beam in a single direction but refers to the movement of the beam to complete a printed component layer by layer.

The system 10 includes an outlet 24 that is movable in the first direction “1D” and is configured to direct gas in a second direction “2D” opposite of the first direction “1D.” In one aspect, the gas may be an inert gas such as argon and nitrogen. A blower 26 is fluidly coupled to the outlet 24 and is configured to blow the gas at a predetermined flow rate that is sufficient to carry particles formed in the cloud created by the fusing process without disturbing the particles in the layer. For example, the blower 26 may be configured to blow the gas at a flow rate of 150-350 m³/hr in an additive process for fusing aluminum particles having an average particle size of 15-63 μm. Such a flow rate is sufficient to carry/blow the aluminum particles in a cloud out of the path of the beam without disturbing or otherwise moving the particles in the layer of particles 18 to be fused. It should be appreciated that the flow rate of the gas may vary based upon the type, size, and mass of the particles being fused and the flow rate may be increased or decreased relative to what is being described without deviating from the scope of the appended claims. FIG. 5 depicts a configuration where the blower 26 is disposed within the outlet 24 and FIG. 6 depicts a configuration where the blower 26 is disposed outside of the chamber 12 and fluidly coupled to the outlet 24. For illustrative purposes, the system 10 is shown as having a pair of blowers 26 each fluidly coupled to opposite ends of the outlet 24. However, it should be appreciated that the system 10 may be configured to use a single blower 26.

With reference now to FIG. 5, the outlet 24 is illustratively shown as an elongated member having a generally cuboidal shape with a slit 28 extending substantially the length of the outlet 24 through which gas is blown. The length of the outlet 24 is smaller than the width of the chamber 12. The cuboidal shape of the outlet 24 is provided for illustrative purposes only and it should be appreciated that the outlet 24 may be shaped otherwise. For instance, the outlet 24 may be cylindrical. The outlet 24 may further include pivotable fins (none shown) which guide the gas through the slit 28. In one aspect, the outlet 24 extends across the width of the chamber 12, and in such an aspect, the slit 28 may also extend across the width of the chamber as shown in FIG. 6.

In another aspect of the system 10, the outlet 24 may be mounted onto a rail system 30. The rail system 30 is configured to guide the outlet 24 in the first direction “1D” along the length of the chamber 12. In one aspect, the rail system 30 includes a pair of rails 30a, 30b and each rail 30a, 30b is spaced apart from each other and is configured to receive a length of the outlet 24. A moving mechanism 32 moves the outlet 24 along the rail system 30. The moving mechanism 32 may be disposed on the outlet 24, on the rail system 30, or reside on both the outlet 24 and the rail system 30. In one aspect, the moving mechanism 32 is a drive piston which is expandable and retractable along the length of the chamber 12. The drive piston includes a first end fixed to the first wall 16a and a second end fixed to a back side 24a of the outlet 24, the back side 24a of the outlet 24 is opposite of a front side 24b of the outlet where the slit 28 is disposed. Any moving mechanism 32 currently known, used, or later developed may be adapted and modified for use herein. For instance, the moving mechanism 32 may be a rotary motor (none shown) disposed on the outlet 24 and coupled to a gear (none shown), the rails 30a, 30b are a track having teeth (none shown) for which the gears may engage so as to advance and retreat the outlet 24 along the track.

The system 10 includes a controller 34 in communication with the outlet 24 and the fusing mechanism 20. The controller 34 is configured to move the outlet 24 in the first direction “1D” and keep the outlet 24 upstream of the beam. The controller 34 may be a programmable logic controller configured to provide the outlet 24 and the fusing mechanism 20 with a set of operating instructions for printing the component. It should be appreciated that the controller 34 may include a memory hardware 34a which includes a plurality of sets of instructions, each set of instructions being associated with a component to be printed. Accordingly, the system 10 may be configured to print different components. It should be appreciated that the fusing path of the fusing mechanism 20 will be different and correspond to the component to be printed. However, the operation and movement of the outlet 24 with respect to the fusing path is substantially the same for all the different components. That is, the outlet 24 advances as the fusing path of the fusing mechanism 20 advances in the first direction “1D” thereby keeping the outlet 24 upstream of the fusing path of the fusing mechanism 20.

In one configuration, the system 10 may include an inlet 36 configured to receive the gas and particles blown by the outlet 24 and direct the gas and blown particles out of the chamber 12. The inlet 36 may be disposed on the second wall 16b and is generally coplanar with the outlet 24. In one aspect, the inlet 36 is fluidly coupled to a trap (none shown) which may include filters and the like for trapping the particles. In another aspect, the inlet 36 is coupled to a vacuum 38 for drawing the gas and particles within the cloud generated by the fusing process out of the chamber 12. It should be appreciated that the vacuum 38 may be configured to sufficiently draw the particles in the cloud into the inlet 36 without disrupting the particles in the layer of particles 18. Accordingly, the vacuum 38 may generate a flow rate that is substantially the same as or less than the flow rate of the blower 26.

With reference again to FIG. 5, the inlet 36 may be fixed on one end of the chamber 12 and spaced apart from the outlet 24. For instance, in configurations where the fusing path of the beam begins at the second wall 16b and moves towards the first wall 16a, the inlet 36 may formed on the second wall 16b so as to be in a fixed position. Thus, the distance between the inlet 36 and the outlet 24 increases as the outlet 24 is moved during the fusion process. In one configuration, the inlet 36 may be an elongated slit 40 formed on the second wall 16b and is generally coplanar with the outlet 24. In yet another aspect, the inlet 36 may be dimensioned to extend along the width of the chamber 12 and is substantially the same length of the outlet 24.

With reference now to FIG. 7, an operation of the system 10 is described. FIG. 7 depicts the system 10 at an initial stage of a first pass of the fusing mechanism 20. The dispensing mechanism 22 has dispensed a layer of particles 18 to be fused prior to the first pass. As used herein, a “pass” refers to the movement of the beam from one end of the chamber 12 to the other end, e.g. from the first wall 16a to the second wall 16b, which indicates the completion of a fusing process for forming a layer of the printed component. The system 10 will make numerous passes to complete the printed component layer-by-layer and the dispensing mechanism 22 dispenses another layer of particles 18 after each pass until the component is complete.

The fusing mechanism 20 generates a beam at a predetermined location of the layer of particles 18 to initiate the fusing path. The fusing path will advance in the first direction “1D” towards the other end of the chamber 12 when the particles within an area defined by a width and length of the chamber 12 have been fused. The blower 26 is actuated as the fusing process occurs and particles in the cloud generated by the fusing process are blown out of the path of the beam along the second direction “2D” which is opposite of the first direction “1D.” As the fusing path advances along the first direction “1D,” the outlet 24 is also advanced. The movement of the beam and the outlet 24 are controlled by the controller 34 which may maintain a predetermined distance between the fusing path of the beam and the outlet 24 to prevent the outlet 24 from obscuring the path of the beam.

With reference now to FIGS. 8-10, the inlet 36 may be moveable with respect to the outlet 24. In such an aspect, the inlet 36 is a separate component having a conduit 42 fluidly connected to a space exterior of the chamber 12. The outlet 24 is configured to direct gas into the inlet 36 wherein the particles of a cloud are carried out of the chamber 12. The inlet 36 may be shaped identical as the outlet 24 as shown in FIG. 8.

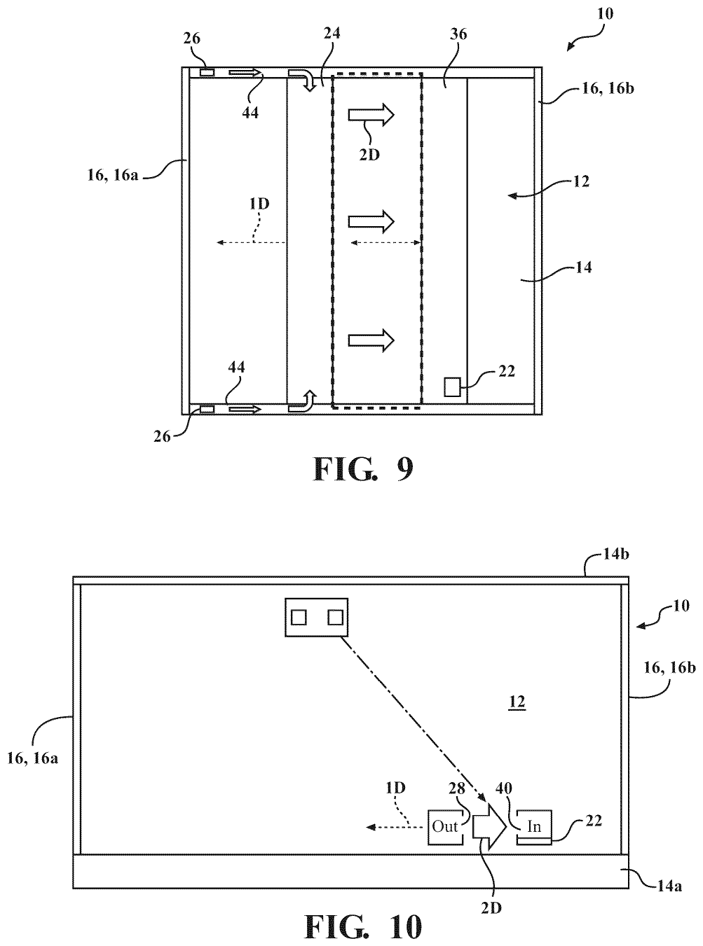

The inlet 36 and the outlet 24 are mounted onto the rail system 30. FIG. 9 shows an aspect of the rail system 30 that is configured to supply gas to the outlet 24 and the dispensing mechanism 22 is disposed within the inlet 36. In such an aspect, the rail system 30 includes a pair of rails 30a, 30b, each having a conduit 44 for directing gas from a blower 26 to the outlet 24. The blower 26 may be disposed within the rail 30a, 30b or external to the rail 30a, 30b. The dispensing mechanism 22 is disposed in the inlet 36 and may include a spreader (none shown) configured to distribute the layer of particles 18 as the inlet 36 moves along the first direction “1D.”

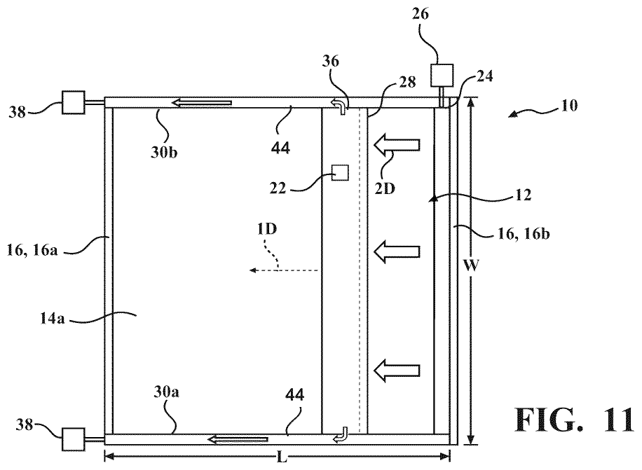

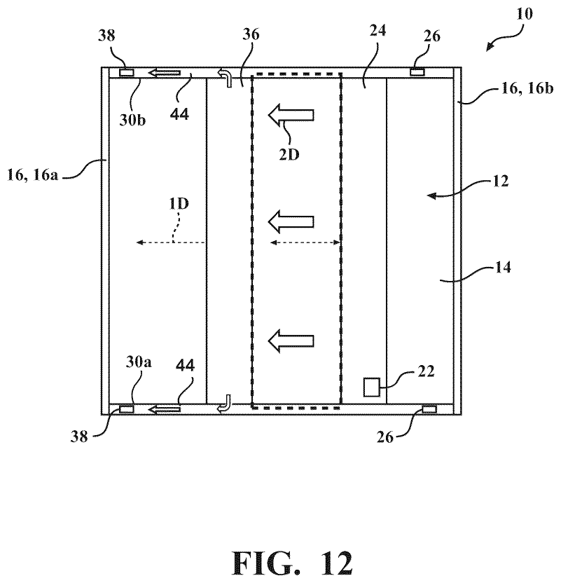

The inlet 36 is spaced apart from the outlet 24 a distance to accommodate the fusing path of the beam. The inlet 36 may be fixed in position relative to the outlet 24 or may be moveable with respect to the outlet 24. In both instances, the inlet 36 and the outlet 24 are movable in the first direction “1D” along the rail system 30. Thus, as the beam advances along the length of the chamber 12 from one end to the other end, the inlet 36 and the outlet 24 move to accommodate the fusing path of the beam, as shown in FIGS. 9 and 10. As the beam fuses the particles, a cloud of particles is generated and the particles in the cloud are blown into the inlet 36 by the gas flowing out of the outlet 24. The path of the beam is relatively unobstructed, as any particles in the cloud that have been fused together are drawn out of the chamber 12, thereby reducing defects in the printed component.

With reference now to FIG. 9, the area disposed between the inlet 36 and the outlet 24 accommodates the fusing path. It should be appreciated that the fusing path need not be performed linearly. That is, the fusing path need not be performed from one side of the chamber 12 to the other side of the chamber 12 or from the outlet 24 towards the inlet 36 but, rather, may span a width and a length of the layer of particles 18. For instance, in fusing mechanisms 20 employing multiple beam generators 20a, 20b, the fusing path of each of the beam generators 20a, 20b may begin at different locations of the area between the inlet 36 and the outlet 24 and once the beam generator completes its fusing path, the outlet 24 and the inlet 36 are advanced along the first direction “1D.” In one aspect, the inlet 36 is in a fixed position relative to the outlet 24 and, thus, the inlet 36 and the outlet 24 move together. In another aspect, the inlet 36 and the outlet 24 may be moveable with respect to each other as indicated by the bi-directional arrow shown in FIG. 9. In such an aspect, the outlet 24 may be advanced in the first direction “1D” before the inlet 36 is advanced, thereby increasing the distance between the inlet 36 and the outlet 24.

With reference now to FIG. 10, the controller 34 is operable to control the fusing mechanism 20, the dispensing mechanism 22, and the moving mechanism 32 to coordinate the movement of the outlet 24 and the inlet 36 with respect to the fusing path of the beam. In particular, the controller 34 may be configured to actuate the moving mechanism 32 to move the outlet 24 and the inlet 36 between a start position (“SP”) and an end position (“EP”) as the fusing mechanism 20 performs the fusing path. FIG. 10 shows the outlet 24 and the inlet 36 having moved from the start position “SP” towards the end position “EP” along the first direction “1D.” It should be appreciated that the controller 34 moves the outlet 24 and the inlet 36 in coordination with the fusing path in such a manner that the outlet 24 remains upstream of the beam and the inlet 36 remains downstream the beam. Thus, particles in the cloud are blown into the inlet 36. When the outlet 24 reaches the end position “EP,” the controller 34 may be further configured to return the beam to the start position “SP” after the fusing mechanism 20 completes the fusing path. The controller 34 is further configured to actuate the dispensing mechanism 22 to dispense another layer of particles 18 into the chamber 12.

In aspects where the dispensing mechanism 22 is a hopper, as illustratively shown in FIG. 7, the controller 34 may actuate the hopper to dispense the layer of particles 18 after the outlet 24 reaches the end position “EP” or after the outlet 24 and the inlet 36 return to the start position “SP.” After the layer of particles 18 is dispensed, the controller 34 actuates the fusing mechanism 20 to execute the fusing path, which may be different than the previous fusing path and actuates the outlet 24 and the inlet 36 in coordination with the advancement of the fusing path along the first direction “1D.” This process is repeated until the component is completed.

In aspects where the dispensing mechanism 22 is disposed within the inlet 36, the controller 34 may be configured to actuate the dispensing mechanism 22 to dispense the layer of particles 18 as the inlet 36 moves along the first direction “1D.” Accordingly, a layer of particles 18 is dispensed as the inlet 36 is advanced. Alternatively, the controller 34 may be configured to actuate the dispensing mechanism 22 as the inlet 36 returns to the start position “SP” from the end position “EP.”

With reference now to FIG. 11, in one aspect of the system 10, the inlet 36 may be moveable with respect to the outlet 24. In such an aspect, the outlet 24 is fixed within the chamber 100. For illustrative purposes, the outlet 24 is shown as being fixed to the second side wall 16b. The outlet 24 is configured to blow an inert gas into the chamber 100 in a direction that is the same as the first direction “1D.” The inlet 36 may include a slit 28 for drawing air into the inlet 36 in a direction the same as the first direction “1D.” The inlet 36 is fluidly connected to a vacuum 38 which may draw the air into a space exterior of the chamber 12.

The inlet 36 is mounted onto the rail system 30 and between the pair of rails 30a, 30b, each having a conduit 44 for directing gas from the inlet 36. The blower 26 may be disposed and fixed within the rail 30a, 30b or external to the rail 30a, 30b. The dispensing mechanism 22 is disposed in the inlet 36 and may include a spreader (none shown) configured to distribute the layer of particles 18 as the inlet 36 moves along the first direction “1D.” As the beam fuses the particles, a cloud of particles is generated and the particles in the cloud are drawn into the inlet 36 by the vacuum 38. The path of the beam is relatively unobstructed, as any particles in the cloud that have been fused together are drawn out of the chamber 12, thereby reducing defects in the printed component.

The area disposed between the inlet 36 and the outlet 24 accommodates the fusing path. It should be appreciated that the fusing path need not be performed linearly. That is, the fusing path need not be performed from one side of the chamber 12 to the other side of the chamber 12 or from the outlet 24 towards the inlet 36 but may span a width and a length of the layer of particles 18. For instance, in fusing mechanisms 20 employing multiple beam generators 20a, 20b, the fusing path of each of the beam generators 20a, 20b may begin at different locations of the area between the inlet 36 and the outlet 24 and once the beam generator completes its fusing path, the inlet 36 is advanced along the first direction “1D.” Thus, FIG. 11 shows an aspect where a distance between the inlet 36 and the outlet 24 increase as the inlet 36 advances along the first direction “1D.”

With reference now to FIG. 12, in one aspect of the system 10, the inlet 36 and the outlet 24 are moveable with along the rail system 30 in the first direction “1D.” In such an aspect, the inlet 36 and the outlet 24 are also moveable with respect to each other so as to accommodate the fusing path. As with the aspect shown in FIG. 11, the vacuum 38 is coupled to the inlet 36 and is configured to draw air into the inlet 36 along the first direction “1D.” The outlet 24 is configured to blow inert gas into the chamber 12 in the first direction “1D”.

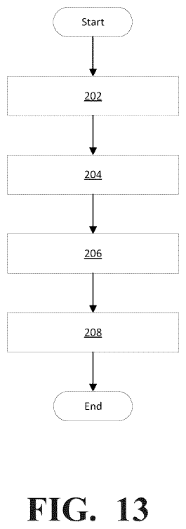

With reference now to FIG. 13, a method 200 for performing additive manufacturing is provided. At step 202 the method includes fusing particles in a layer of particles 18 with a beam. The beam moves in a fusing path from one end of a chamber 12 to another end of the chamber 12 in a first direction “1D.” Fusing particles in a layer of particles 18 with a beam may be performed using a laser beam or an electron beam. The fusing path may extend along both a portion of the length of the chamber 12 and a portion of the width of the chamber 12 based upon the design of the component to be printed.

At step 204, the method includes providing an outlet 24 for blowing gas in a second direction “2D” opposite of the first direction “1D,” and moving the outlet 24 along the first direction “1D.” The gas may be an inert gas configured to minimize interference with the beam. The outlet 24 may extend along the width of the chamber 12 and may be moved along a rail 30a, 30b that extends along a length of the chamber 12. It should be appreciated that steps 102 and 104 may be performed concurrently.

At step 206, the method includes keeping the outlet 24 upstream of the fusing path so as to blow air downstream of the fusing path. Accordingly, the outlet 24 is moved as the beam generated by the fusing mechanism 20 moves along the first direction “1D.” It should be appreciated that the outlet 24 is not moved immediately or simultaneously with the movement of a beam in the first direction “1D” but may be moved when the beam is within a predetermined distance of the outlet 24. For instance, the outlet 24 may be moved in the first direction “1D” when the beam approaches within 50 mm of the outlet 24.

At step 208, the method may include providing an inlet 36 configured to draw air from within the chamber 12 to an environment external to the chamber 12. The inlet 36 may be spaced apart from the outlet 24 a predetermined distance to accommodate the fusing path. The inlet 36 may be a tubular or cuboidal structure extending along a width of the chamber 12. The inlet 36 includes a slit for receiving the particles blown by the outlet 24.

The method may include moving the inlet 36 with respect to the outlet 24 by a controller 34, wherein the controller 34 moves the inlet 36 and the outlet 24 to accommodate the fusing path of the beam. The controller 34 may be further configured to move the outlet 24 and the inlet 36 between a start position “SP” and an end position “EP.” The printing process begins at the start position “SP” and a first layer of the component is printed when the outlet 24 reaches the end position “EP.” The method may include maintaining, by the controller 34, the outlet 24 upstream of the beam and the inlet 36 downstream the beam as the beam moves in the fusing path, and returning the beam to the start position when the beam completes the fusing path. The method may include adding another layer of particles 18 to be printed. This may be done by providing the inlet 36 with a dispensing mechanism 22 for dispensing particles as the inlet 36 is moved from the start position “SP” to the end position “EP.” In aspects where the dispensing mechanism 22 is a hopper, the particles may be dispensed after the outlet 24 reaches the end position “EP” or the start position “SP.”

Accordingly, a system and method for additive manufacturing includes an outlet that is moveable in the first direction “1D” and maintains the outlet upstream of the beam. The outlet is configured to blow air in a second direction “2D” opposite of the first direction “1D” thereby blowing away particles in a cloud out of the path of the beam of the fusing mechanism. Further, any particles in the cloud that are fused are drawn out of the chamber and reduces imperfections in the printed component. Further, as the outlet is moveable along the chamber, the size of the chamber is unlimited and, thus, the size of the component to be printed by the additive manufacturing process is also unlimited.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for additive manufacturing, the system including a chamber containing a layer of particles, the system comprising:
a fusing mechanism transmitting a beam for fusing particles in the layer of particles, the fusing mechanism configured to move the beam in a fusing path, the fusing path extending from one end of the chamber to another end of the chamber in a first direction;
an outlet movable in the first direction and configured to blow air in a second direction, the second direction being opposite of the first direction; and
a controller configured to move the outlet in the first direction and keep the outlet upstream of the beam, the outlet blowing the particles in a cloud of particles away from the layer of particles.

2. The system as set forth in claim 1, wherein the beam is one of a laser beam and an electron beam.

3. The system as set forth in claim 1, wherein the outlet extends along a width of the chamber.

4. The system as set forth in claim 1, further comprising a rail, the rail extending along a length of the chamber, the outlet movably disposed along the rail.

5. The system as set forth in claim 1, further comprising an inlet configured to draw air from within the chamber to an environment external to the chamber.

6. The system as set forth in claim 5, wherein the inlet is spaced apart from the outlet.

7. The system as set forth in claim 6, wherein the inlet is moveable with respect to the outlet to accommodate the fusing path of the beam.

8. The system as set forth in claim 7, wherein the controller is configured to move the outlet and the inlet between a start position and an end position.

9. A system for additive manufacturing, the system including a chamber containing a layer of particles, the system comprising:
a fusing mechanism transmitting a beam for fusing particles in the layer of particles, the fusing mechanism configured to move the beam in a fusing path extending from one end of the chamber to another end of the chamber in a first direction;
an inlet movable in the first direction and configured to draw air in the first direction; and
a controller configured to move the inlet in the first direction and keep the inlet upstream of the beam.

10. The system as set forth in claim 9, further including an outlet configured to blow air in the first direction, the outlet spaced apart from the inlet.

11. A method for performing additive manufacturing comprising:
fusing particles in a layer of particles with a beam, the beam moving in a fusing path from one end of a chamber to another end of the chamber in a first direction;
providing an outlet for blowing air in a second direction opposite of the first direction; and
moving the outlet along the first direction and keeping the outlet upstream of the fusing path.

12. The method as set forth in claim 11, wherein fusing particles in a layer of particles with a beam includes using one of a laser beam and an electron beam.

13. The method as set forth in claim 11, wherein the outlet extends along a width of the chamber.

14. The method as set forth in claim 11, wherein moving the outlet along the first direction includes moving the outlet along a rail, the rail extending along a length of the chamber.

15. The method as set forth in claim 14, further comprising providing an inlet configured to draw air from within the chamber to an environment external to the chamber.

16. The method as set forth in claim 15, further comprising spacing the inlet apart from the outlet a predetermined distance to accommodate the fusing path.

17. The method as set forth in claim 15, wherein the inlet extends along a width of the chamber.

18. The method as set forth in claim 16, further comprising moving, by a controller, the inlet with respect to the outlet to accommodate the fusing path of the beam.

19. The method as set forth in claim 18, further comprising moving, by the controller, the outlet and the inlet between a start position and an end position.

20. The method as set forth in claim 19, further comprising maintaining, by the controller, the outlet upstream of the beam and the inlet downstream the beam as the beam moves in the fusing path, and returning the beam to the start position when the beam completes the fusing path.
